(19) United States
(12) Patent Application Publication
(10) Pub. No.: US 2016/0005057 A1
(43) Pub. Date: Jan. 7, 2016

(54) SYSTEMS AND METHODS FOR PERFORMING POLLS AND SURVEYS ACROSS HETEROGENOUS PLATFORMS

(71) Applicant: QVO, Inc., Irvine, CA (US)

(72) Inventor: Brandon Paul Zavala, Anaheim, CA (US)

(21) Appl. No.: 14/321,326

(22) Filed: Jul. 1, 2014

(51) Int. Cl. G06Q 30/02

(52) U.S. Cl. CPC G06Q 30/0203

(57) ABSTRACT

Computer implemented systems and methods for creating communications, transmitting the communications or links to the communications to contacts on heterogenous platforms, and analyzing the responses to the communications.

### BACKGROUND OF THE INVENTION

The subject matter described herein relates to conducting poll and surveys, or soliciting opinions from various users across multiple platforms and presenting contents to users based upon their opinions.

### SUMMARY OF THE INVENTION

In particular, the subject matter described herein allows more efficient poll/survey management. For example, the system processes polls and/or surveys across heterogeneous platforms in order to streamline the process. Further, the subject matter described herein provides a benefit poll creators in saving processing time and gaining more accurate responses.

In one aspect, described herein is a computer-implemented system comprising: (a) a digital processing device comprising an operating system configured to perform executable instructions and a memory device; (b) a database of contacts; (c) a computer program including instructions executable by the digital processing device to execute an application comprising: (i) a software module configured to create a communication; (ii) a software module configured to transmit the communication or a link to the communication to a contact, provided that the communication is transmitted on two or more communication modes or platforms of the contact; (iii) a software module configured to receive a response to the communication; and (iv) a software module configured to analyze the response.

In another aspect, described herein is a computer-implemented method comprising: (a) receiving a database of contacts; (b) creating a communication; (c) transmitting the communication or a link to the communication to a contact, provided that the communication is transmitted on two or more communication modes or platforms of the contact; (d) receiving a response to the communication; and (e) analyzing the response.

In another aspect, described herein is a computer-implemented system comprising: (a) a digital processing device comprising an operating system configured to perform executable instructions and a memory device; (b) a database of contacts; (c) a computer program including instructions executable by the digital processing device to execute an application comprising: (i) a software module configured to create an invite; (ii) a software module configured to transmit the invite or a link to the invite to a contact, provided that the invite is transmitted on two or more communication modes or platforms of the contact; (iii) a software module configured to receive a response to the invite; and (iv) a software module configured to analyze the response.

In another aspect, described herein is a computer-implemented system comprising: (a) a digital processing device comprising an operating system configured to perform executable instructions and a memory device; (b) a database of contacts; (c) a computer program including instructions executable by the digital processing device to execute an application comprising: (i) a software module configured to create a quiz; (ii) a software module configured to transmit the quiz or a link to the quiz to a contact, provided that the quiz is transmitted on two or more communication modes or platforms of the contact; (iii) a software module configured to receive a response to the quiz; and (iv) a software module configured to analyze the response.

In another aspect, described herein is a computer-implemented system to comprising: (a) a digital processing device comprising an operating system configured to perform executable instructions and a memory device; (b) a database of contacts; (c) a computer program including instructions executable by the digital processing device to execute an application comprising: (i) a software module configured to create a communication during a shopping process; (ii) a software module configured to transmit the communication or a link to the communication to a contact, provided that the communication is transmitted on two or more communication modes or platforms of the contact; (iii) a software module configured to receive a response to the communication; and (iv) a software module configured to analyze the response.

In another aspect, described herein is a computer-implemented system comprising: (a) a digital processing device comprising an operating system configured to perform executable instructions and a memory device; (b) a database of contacts; (c) a computer program including instructions executable by the digital processing device to execute an application comprising: (i) a software module configured to create a communication; (ii) a software module configured to transmit to a contact with an image linked to the communication, provided that the communication is transmitted on two or more communication modes or platforms of the contact; (iii) a software module configured to receive a response to the communication; and (iv) a software module configured to analyze the response.

### BRIEF DESCRIPTION OF THE DRAWINGS

FIG. 1 shows an illustrative flowchart of a poll and/or survey creation system; in this case, the user enters the login page, creates a poll by entering questions and choices, selects the poll type, and determines the contacts for sending the poll/survey.

FIG. 2 shows illustrative flowcharts of sponsored polls; in this case, the user designs two possible options to allow voter to complete a poll or answer a question.

FIG. 3 shows illustrative flowcharts of business polls; in this case, the user designs two possible options to allow voter to complete a poll and then receive a promotion.

FIG. 4 shows an illustrative flowchart of integrating items in a poll; in this case, the user creates an online wishlist or shopping cart poll, compiles items into the poll, and sends the poll to private or public contacts.

FIG. 5 shows an illustrative flowchart of integrating pictures in a poll; in this case, the user creates a poll or survey, links or adds pictures into the poll or survey, and then allows voters to vote.

FIG. 6 shows an illustrative example of a graphical interface of the system; in this case, a user could determine which task (create poll, vote for a poll, or view poll results) he/she wanted to do.

FIG. 7 shows an illustrative example of sending an event invitation using the system; in this case, the user was allowed to enter the details of the event, and the location and time of the event.

FIG. 8 shows an illustrative example of creating a public poll; in this case, the system guided a user to begin a public poll creation.

FIG. 9 shows an illustrative example of creating a public poll; in this case, the user was asked to select a poll type and to determine how the questions were going to be created.

FIG. 10 shows an illustrative example of creating a public poll; in this case, the user was asked more detail information about the poll.

FIG. 11 shows an illustrative example of creating a public poll; in this case, the user was asked to publish the poll questions on which platform, including social media (e.g., Facebook, Twitter, LinkedIn) or specific websites.

FIG. 12 shows an illustrative example of creating a private poll; in this case, the interface allowed the user to determine which contacts will be invited to join the poll.

FIG. 13 shows an illustrative example of creating a private poll on a wedding event; in this case, the user entered pictures of possible wedding dresses to allow the responder to vote on a scale.

FIG. 14 shows an illustrative example of creating a private poll on a wedding event; in this case, the responder was allowed to vote by a drag-and-drop method to rank the preference.

FIG. 15 shows an illustrative example of creating a private poll on a wedding event; in this case, the response was based multiple choice questions.

FIG. 16 shows an illustrative example of creating a private poll on a wedding event; in this case, the poll asked a preferred place to hold the wedding.

FIG. 17 shows an illustrative example of a private poll; in this case, a user asked friends where to go after watching a baseball game.

FIG. 18 shows an illustrative example of a private poll; in this case, the choices listed people having responded to the questions.

FIG. 19 shows an illustrative example of a poll management; in this case, a user interface displayed the trending of existing polls, the categories of the polls, the private polls, and the public polls.

FIG. 20 shows an illustrative example of a poll management; in this case, the system summarized the status of polls.

### DETAILED DESCRIPTION OF THE INVENTION

In some embodiments, the subject matter described herein comprises a computer-implemented poll or survey system comprising: (a) a digital processing device comprising an operating system configured to perform executable instructions and a memory device; (b) a database of contacts; (c) a computer program including instructions executable by the digital processing device to execute an application comprising: (i) a software module configured to create a communication; (ii) a software module configured to transmit the communication or a link to the communication to a contact, provided that the communication is transmitted on two or more communication modes or platforms of the contact; (iii) a software module configured to receive a response to the communication; and (iv) a software module configured to analyze the response.

In various embodiments, the subject matter described herein comprises a computer-implemented method comprising: (a) receiving a database of contacts; (b) creating a communication; (c) transmitting the communication or a link to the communication to a contact, provided that the communication is transmitted on two or more communication modes or platforms of the contact; (d) receiving a response to the communication; and (e) analyzing the response.

In various embodiments, the subject matter described herein comprises a computer-implemented invitation system comprising: (a) a digital processing device comprising an operating system configured to perform executable instructions and a memory device; (b) a database of contacts; (c) a computer program including instructions executable by the digital processing device to execute an application comprising: (i) a software module configured to create an invite; (ii) a software module configured to transmit the invite or a link to the invite to a contact, provided that the invite is transmitted on two or more communication modes or platforms of the contact; (iii) a software module configured to receive a response to the invite; and (iv) a software module configured to analyze the response.

In some embodiments, the subject matter described herein comprises a computer-implemented exam system comprising: (a) a digital processing device comprising an operating system configured to perform executable instructions and a memory device; (b) a database of contacts; (c) a computer program including instructions executable by the digital processing device to execute an application comprising: (i) a software module configured to create a quiz; (ii) a software module configured to transmit the quiz or a link to the quiz to a contact, provided that the quiz is transmitted on two or more communication modes or platforms of the contact; (iii) a software module configured to receive a response to the quiz; and (iv) a software module configured to analyze the response.

In some embodiments, the subject matter described herein comprises a computer-implemented poll or survey system during a shopping process, the system comprising: (a) a digital processing device comprising an operating system configured to perform executable instructions and a memory device; (b) a database of contacts; (c) a computer program including instructions executable by the digital processing device to execute an application comprising: (i) a software module configured to create a communication during a shopping process; (ii) a software module configured to transmit the communication or a link to the communication to a contact, provided that the communication is transmitted on two or more communication modes or platforms of the contact; (iii) a software module configured to receive a response to the communication; and (iv) a software module configured to analyze the response.

In some embodiments, the subject matter described herein comprises a computer-implemented instagram system comprising: (a) a digital processing device comprising an operating system configured to perform executable instructions and a memory device; (b) a database of contacts; (c) a computer program including instructions executable by the digital processing device to execute an application comprising: (i) a software module configured to create a communication; (ii) a software module configured to transmit to a contact with an image linked to the communication, provided that the communication is transmitted on two or more communication modes or platforms of the contact; (iii) a software module configured to receive a response to the communication; and (iv) a software module configured to analyze the response.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Contact

In some embodiments, the system, media and methods described herein comprises a contact. In some embodiments, a contact a person or a business entity. In certain embodiments, contacts are organized in a database; the database of contacts comprises a business account of a contact, a personal account of a contact, an email address of a contact, a phone number of a contact, a social media account of a contact, a webpage of a contact, or a combination of thereof.

### Communication

In some embodiments, the system, media and methods described herein comprises a communication. In various embodiments, the communication comprises a poll, a survey, an invite, a quiz, a message, or a contact, or a combination of thereof. In some instances, the communication is a private communication unique to a contact, or a public communication accessible by two or more contacts. In certain embodiments, the communication is associated with one or more of the following: an experience, an opinion, a rating, a ranking, a favor, a preference, a feeling, a dislike, and a gambling. In additional embodiments, betting is an example of gambling.

In some embodiments, the communication is conveyed via a communication medium; the communication medium comprises one or more of the following: a webpage, a video file, an audio file, an image, a text, and a linkable text. In some embodiments, the link to the communication is a private link unique to a contact. In some embodiments, the link to the communication is a public link accessible by two or more contacts. In other embodiments, the communication is conveyed via a communication medium or embedded in a communication medium, which comprises a webpage, a video file, an audio file, an image, or a text.

In some embodiments, the system, media, and methods described herein include a communication mode or platform. The communication mode or platform comprises an email address, a phone number, a short message service, a website address, or a webpage address.

### Response to Communication

In some embodiments, described herein include two or more responses to a communication made on distinct communication modes or platforms, each platform associated with the same contact. In some embodiments, responses are analyzed. Non-limiting examples include analyzing the response comprises removing a duplicate response made by the same contact.

Alternatively, two or more responses are made on distinct communication modes or platforms, each platform associated with a different contact. In some embodiments, analyzing the responses comprises interpreting the responses. In various embodiments, analyzing the responses comprises making a statistical summary of the current responses and past received responses.

### Software Application

In some embodiments, the system described herein include a software application, or use of the same. In some embodiments, the application comprises a software module configured to create a communication. In various embodiments, the application comprises a software module configured to transmit the communication or a link to the communication to a contact, provided that the communication is transmitted on two or more communication modes or platforms of the contact. In certain embodiments, the application comprises a software module configured to receive a response to the communication and a software module configured to analyze the response.

In some embodiments, the system is provided with an application comprising a software module configured to present the statistical summary.

In some embodiments, the system is provided with an application comprising a software module configured to apply a discount to the contact's shopping process instantly after the contact responds to the question.

In some embodiments, the system is provided with an application comprising a software module configured to issue a promotion message after a contact responds to the question. In some embodiments, the promotion message comprises a coupon or promotion code.

In some embodiments, the system is provided with an application comprising a software module configured to organize questions and responses into a database.

In some embodiments, the database of questions in communications and responses to communications is offered for sale.

In additional embodiments, the software application is a software as a service.

### System Design

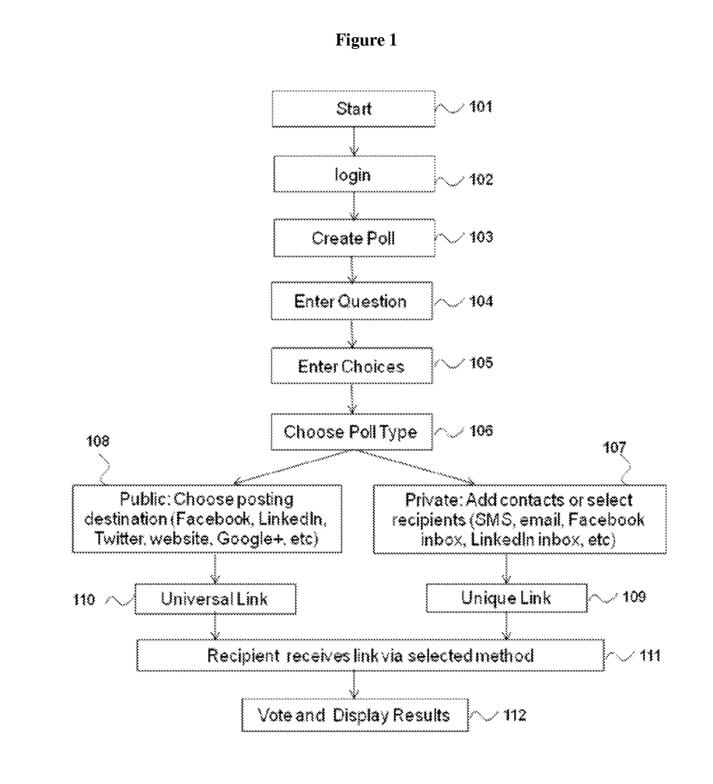

FIG. 1 shows an embodiment of a system. In steps 101 and 102, a poll/survey creator enters the login page. Then the creator creates a poll (103) by entering questions and choices (104 and 105). Then, the creator selects the poll type: public 108 or private 107. In the application of pubic poll/survey, the creator lets the system know a publically available destination 110 (e.g., websites, social media, emails, and phone numbers) for the public poll/survey. In the application of private poll/survey, the creator adds the information of contacts (e.g., websites, social media, emails, and phone numbers) and generates unique links to the contacts 109. Finally, the recipients of the poll/survey respond to the poll/survey 111. The system collects the responses, and then analyzes or shows the results 112.

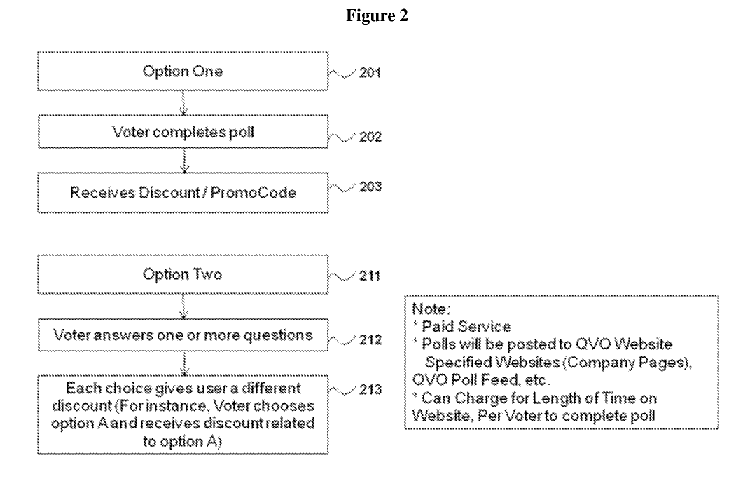

FIG. 2 illustrates flowcharts of sponsored polls. Option one 201-203 allows a voter to complete a poll and then the voter receives a promotion or discount. Option two 211-213 allows a voter to answer questions, where each choice gives user a different discount. For example, voter chooses option A and receives discount related to option A.

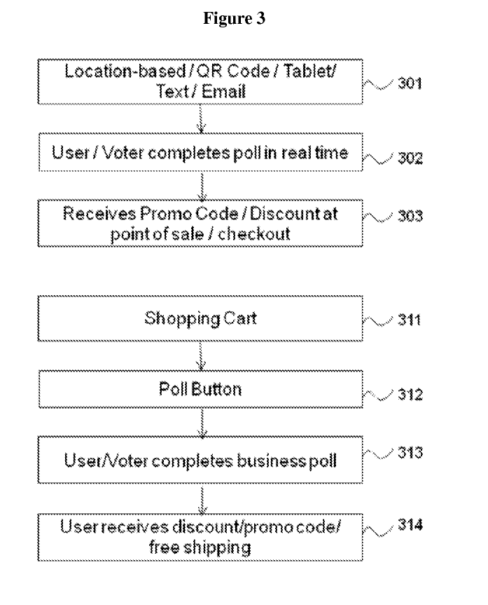

FIG. 3 illustrates flowcharts of business polls. In one embodiment 301-303, votors of the poll receive communications based on location, which can be embedded in QR code, text, emails; the voter completes the poll real time and receives a discount or a promotion immediately. In another embodiment 311-314, voters are in a process of online shopping or in-store shopping, people receiving a poll/survey can receive a discount/promotion once the poll/survey is complete.

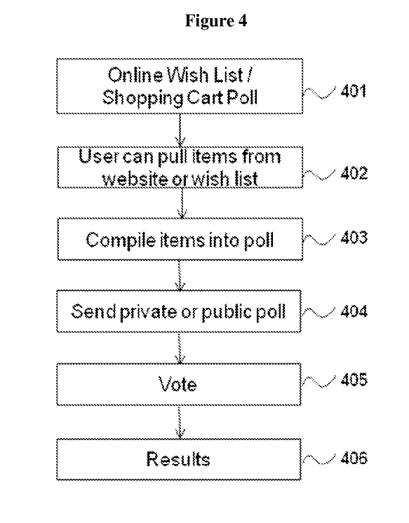

FIG. 4 illustrates a flowchart of integrating items in a poll. The user of the system creates an online wishlist or shopping cart poll 401, compiles items into the poll 402-403, and sends the poll to private or public contacts 404. Finally, voters cast their votes 405 and the system analyzes the results 406.

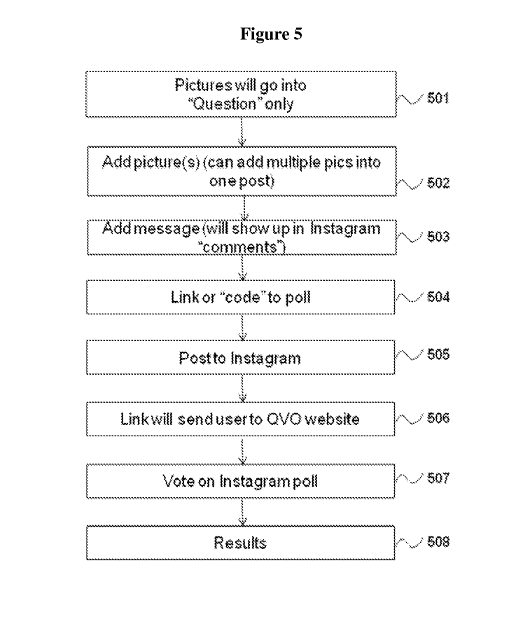

FIG. 5 illustrates a flowchart of integrating pictures in a poll. The user creates a poll or survey 501, links or adds pictures into the poll or survey 502, adds message 503, links or codes the poll 504, posts to instagram 505, sends the link or poll/survey 506, and then allows voters to vote 507. Finally, the system analyzes/presents the results 508.

### Digital Processing Device

In some embodiments, the signs, systems, networks, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® P53®, Sony® P54®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

### Non-Transitory Computer Readable Storage Medium

In some embodiments, the signs, systems, networks, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the signs, systems, networks, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Software Modules

In some embodiments, the signs, systems, networks, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the signs, systems, networks, and methods disclosed herein include one or more databases, or use of the same. In view of the disclosure provided herein, those of skill in the art will recognize that many databases are suitable for storage and retrieval of sign configuration, user, and advertising information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way.

### Example 1

### Graphic User Interface of the System

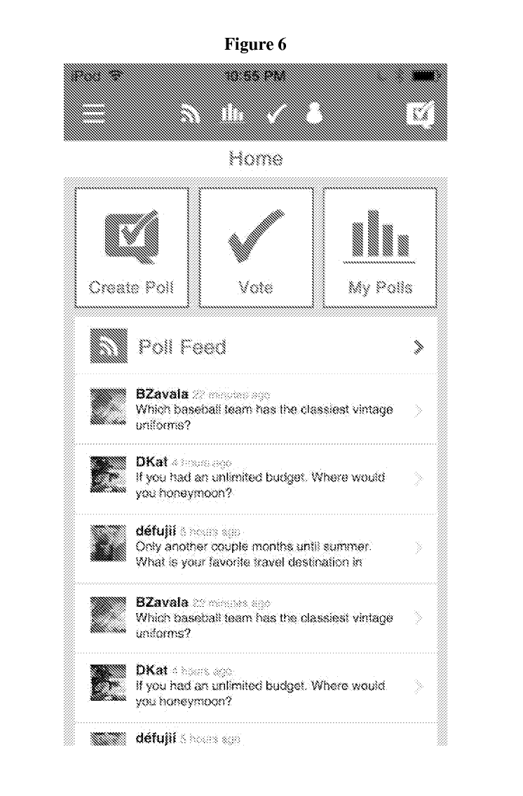

FIG. 6 shows an example of portal home of the system. In this example, a user could determine which task (create poll, vote, view poll results) he/she wanted to do. Meanwhile, real-time feed of the polls/surveys were displayed on the screen.

### Example 2

### Invitation Creation System

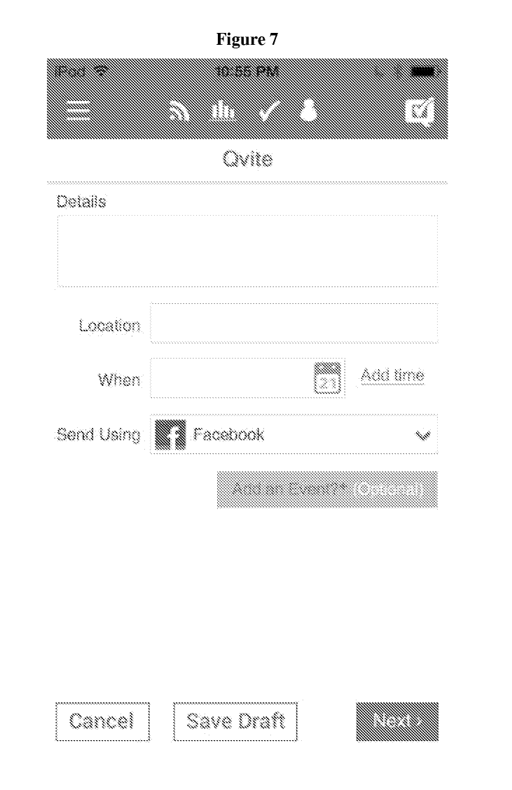

FIG. 7 shows an example of sending an event invitation using the system. In this example, the user was allowed to enter the details of the event, and the location and time of the event. Furthermore, the event can be linked or posted on a social media platform.

### Example 3

### Public Poll Creation

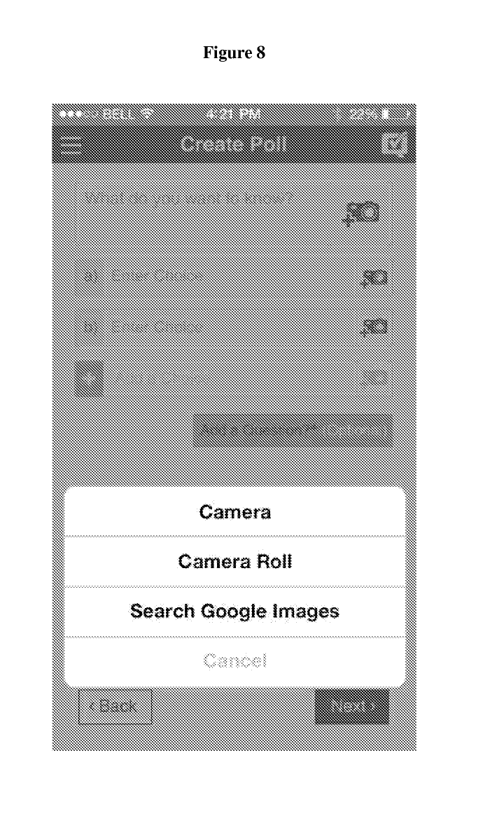

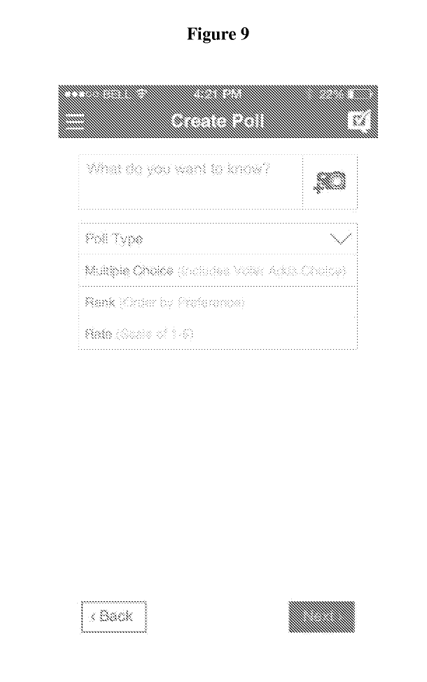

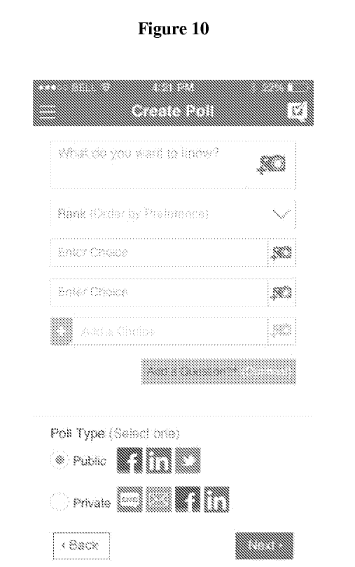

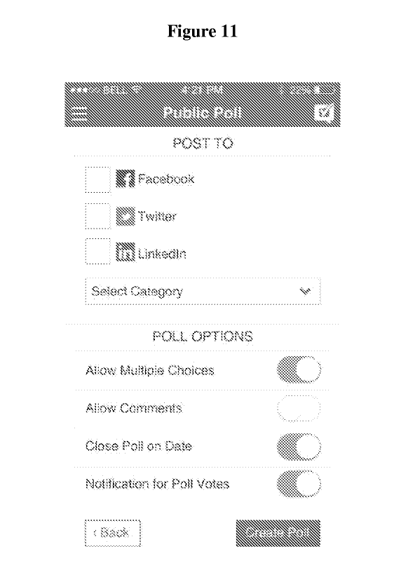

FIG. 8 to FIG. 11 show an example of creating a public poll. FIG. 8 shows that the system guided a user to begin a public poll creation; in this example, the user was allowed to include an picture (from camera, camera roll, or the Internet) in the poll. Next, FIG. 9 shows that the user was asked to select the poll type and how the questions were going to be created. FIG. 10 shows that the user was asked more detail information about the poll. FIG. 11 shows that the user was asked to publish the poll questions on which platform, including social media (e.g., Facebook, Twitter, LinkedIn) or specific websites.

### Example 4

### Private Poll/Survey

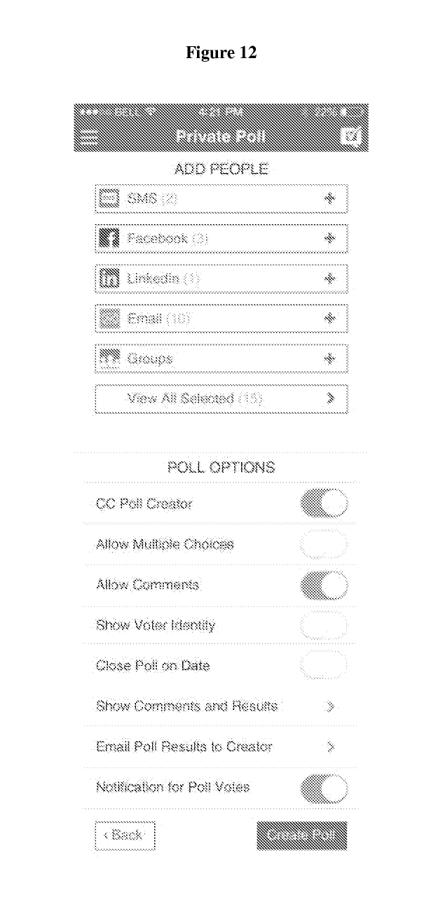

FIG. 12 shows an example of private poll. In this example, the interface allowed the user to determine which contacts will be invited to join the poll. In addition, extra setting of privacy was requested to make the poll/survey private.

### Example 5

### Private Poll/Survey on Wedding Event

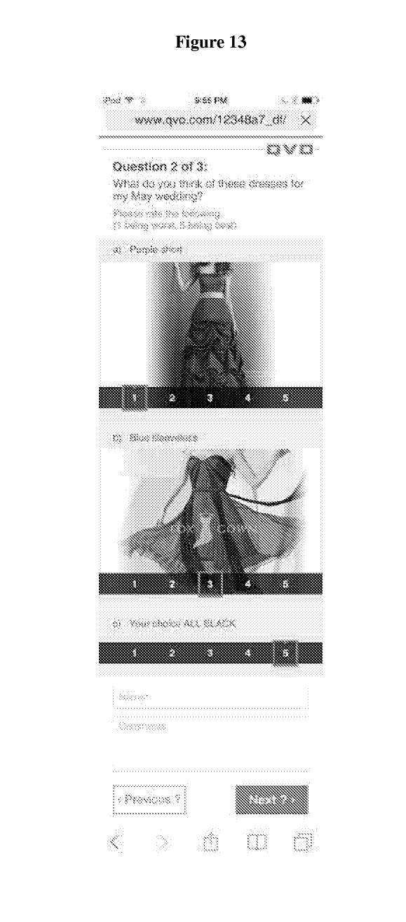

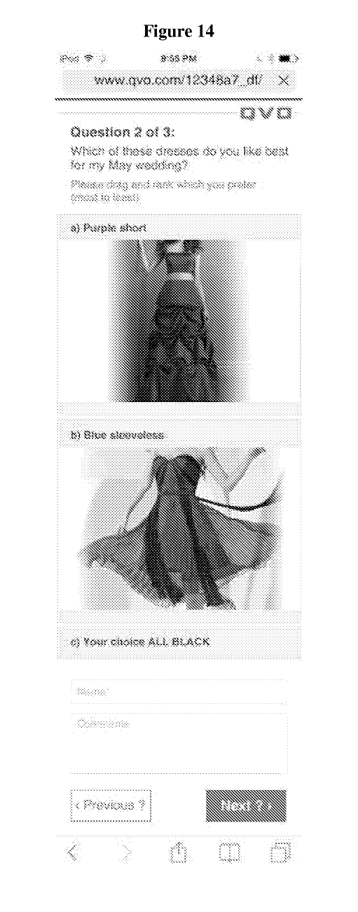

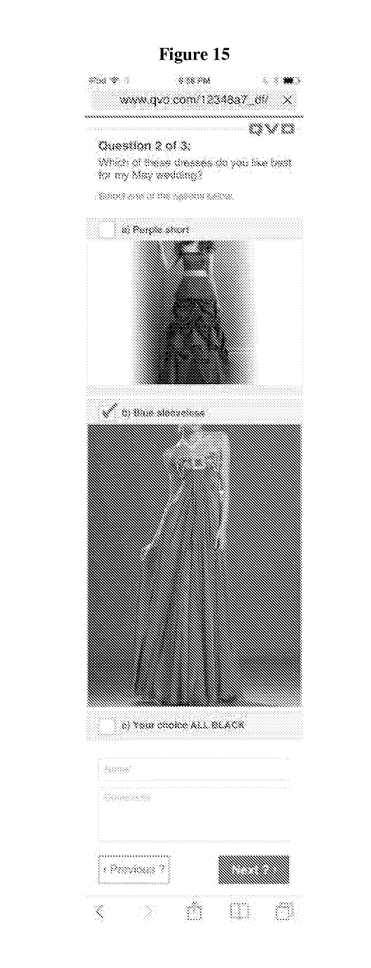

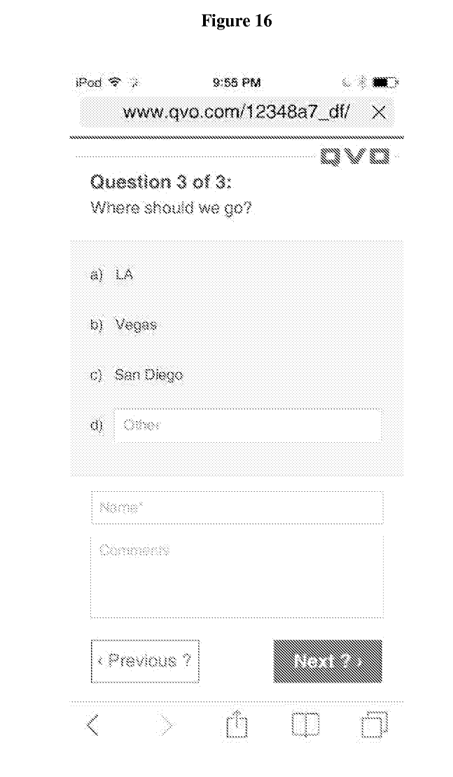

FIG. 13 to FIG. 16 show an example of private poll/survey on a wedding event. In FIG. 13, FIG. 14 and FIG. 15, the user entered pictures of possible wedding dresses to allow the responder to vote. In FIG. 13, the vote was based on scale from 1 to 5, and FIG. 14 was based on a drag-and-drop method to rank the preference. FIG. 15 was based a multiple choice questions to let the voter choose. In FIG. 16, the responder was asked a place to hold the wedding.

### Example 6

### Sports Event

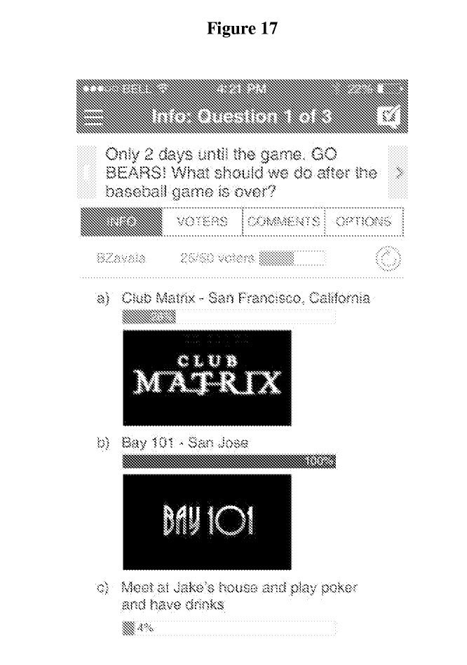

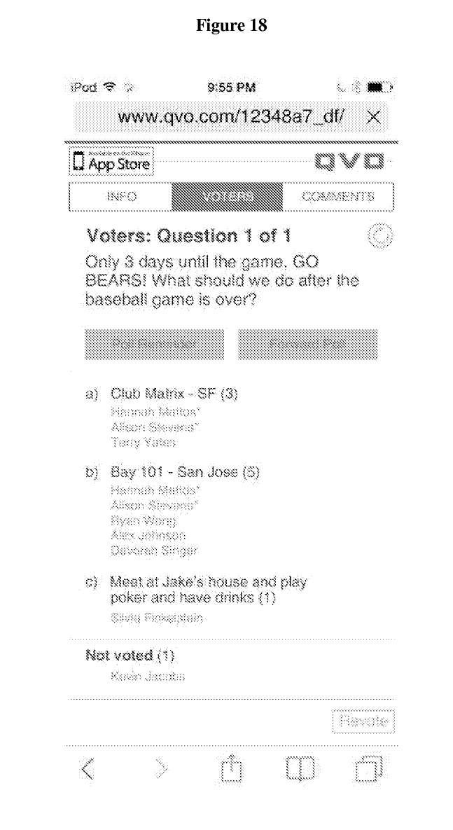

FIG. 17 and FIG. 18 show an example of private poll. In FIG. 17, the poll creator asked his friends where to go after watching a baseball game. The options included texts, figures, and current status of the votes. In FIG. 18, the choices listed people responding to the questions and their votes on the choices.

### Example 7

### Poll/Survey Management

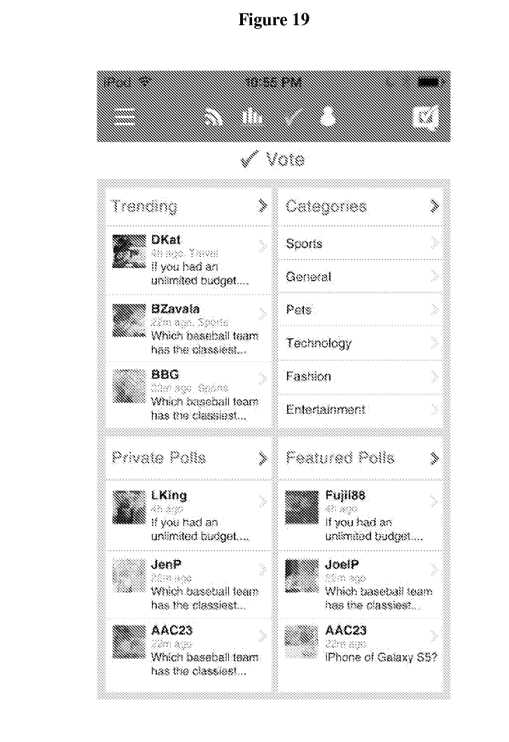

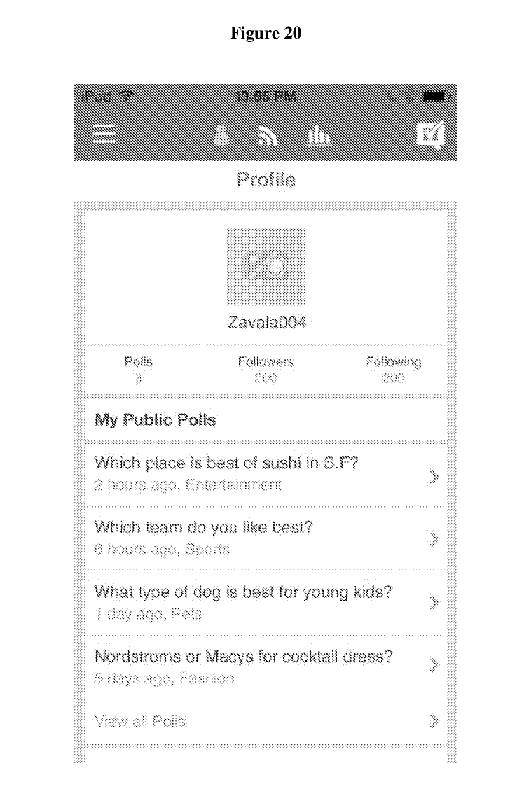

FIG. 19 and FIG. 20 show an example of poll/survey management or organization. In FIG. 19, a user interface displayed the trending of existing polls, the categories of the polls, the private polls, and the public polls. In FIG. 20 the system displayed to the user his private polls. Summaries of the poll status were presented.

1. A computer-implemented system comprising:
(a) a digital processing device comprising an operating system configured to perform executable instructions and a memory device;
(b) a database of contacts, the database comprising a personal account of a contact, an email address of a contact, a phone number of a contact, a social media account of a contact, or a webpage of a contact;
(c) a computer program including instructions executable by the digital processing device to execute an application comprising:
(i) a software module configured to create a communication;
(ii) a software module configured to transmit the communication or a link to the communication to a contact, provided that the communication is transmitted on two or more communication modes or platforms of the contact;
(iii) a software module configured to receive a response to the communication; and
(iv) a software module configured to analyze the response.

2. The system of claim 1, provided that a contact comprises a person or a business entity.

3. (canceled)

4. (canceled)

5. (canceled)

6. (canceled)

7. (canceled)

8. (canceled)

9. The system of claim 1, provided that the communication comprises one or more of the following: a poll, a survey, an invite, a quiz, and a message.

10. (canceled)

11. (canceled)

12. (canceled)

13. (canceled)

14. The system of claim 1, provided that the communication is dependent on a location of a contact.

15. The system of claim 1, provided that the communication is a private communication unique to a contact, or a public communication accessible by two or more contacts.

16. (canceled)

17. The system of claim 1, provided that the communication is associated with one or more of the following: an experience, an opinion, a rating, a ranking, a favor, a preference, a feeling, a dislike, and a gambling.

18. The system of claim 1, provided that the communication is conveyed via a communication medium, wherein the communication medium comprises one or more of the following: a webpage, a video file, an audio file, an image, a text, and a linkable text.

19. (canceled)

20. (canceled)

21. (canceled)

22. (canceled)

23. (canceled)

24. (canceled)

25. The system of claim 1, provided that the link to the communication is a private link unique to a contact, or a public link accessible by two or more contacts.

26. (canceled)

27. The system of claim 1, provided that the link to the communication is conveyed via a communication medium or embedded in a communication medium, wherein the communication medium comprises one or more of the following: a webpage, a video file, an audio file, an image, and a text.

28. (canceled)

29. (canceled)

30. (canceled)

31. (canceled)

32. (canceled)

33. The system of claim 1, provided that the communication mode or platform comprises one or more of the following: an email address, a phone number, a short message service, a website address, and a webpage address.

34. (canceled)

35. (canceled)

36. (canceled)

37. (canceled)

38. The system of claim 1, provided that two or more responses are made on distinct communication modes or platforms, each platform associated with the same contact.

39. (canceled)

40. The system of claim 1, provided that two or more responses are made on distinct communication modes or platforms, each platform associated with a different contact.

41. The system of claim 1, provided that analyzing the response comprises one or more of the following: interpreting the response, removing a duplicate response made by a same contact, and making a statistical summary of the response and past received responses.

42. (canceled)

43. The system of claim 41, provided that the application further comprises a software module configured to present the statistical summary.

44. The system of claim 1, provided that the application further comprises a software module configured to apply a discount to the contact's shopping process instantly after the contact responds to the question.

45. The system of claim 1, provided that the application further comprises a software module configured to issue a promotion message after a contact responds to the question.

46. The system of claim 45, provided that the promotion message comprises a coupon or promotion code.

47. The system of claim 1, provided that the application further comprises a software module configured to organize questions and responses into a database.

48. The system of claim 47, provided that the database of questions and response is offered for sale.

49. The system of claim 1, provided that the application is a software as a service.

50.-261. (canceled)
